(19) United States
(12) Patent Application Publication
(10) Pub. No.: US 2006/0000076 A1
(43) Pub. Date: Jan. 5, 2006

(54) Method of using a container assembly

(76) Inventors: Thomas J. Hayes, McHenry, IL (US); Scott D. Brown, Winthrop Harbor, IL (US)

Correspondence Address: JENKENS & GILCHRIST, P.C., 225 WEST WASHINGTON, SUITE 2600, CHICAGO, IL, 60606, US

(21) Appl. No.: 11/152,263

(22) Filed: Jun. 14, 2005

Related U.S. Application Data
(63) Continuation-in-part of application No. 10/840,974, filed on May 7, 2004.
Application No. 10/840,974 is a continuation of application No. 10/277,303, filed on Oct. 22, 2002, now Pat. No. 6,886,704.
(60) Provisional application No. 60/581,403, filed on Jun. 21, 2004.

(51) Int. Cl. B23P 19/00

(52) U.S. Cl. 29/426.5; 29/426.1

(57) ABSTRACT

A method of opening a container assembly comprises providing a container assembly with first and second containers. Each of the containers includes a continuous body portion and a rim. The rim encompasses and projects laterally outwardly from the body portion. The rim has a plurality of features projecting generally upwardly therefrom such that spaces are formed between adjacent features. The first and second rims are shaped substantially the same. The containers are releasably engageable to each other to form the container assembly by fitting the respective plurality of upwardly-projecting features into respective spaces. The container assembly is opened by exerting downward pressure on one of the continuous body portions resulting in the disengagement of the first and second rims from each other.

### RELATED APPLICATION

This application claims benefit of U.S. Provisional Application Ser. No. 60/581,403 entitled “Method of Using A Container Assembly”, filed on Jun. 21, 2004; this application is a continuation-in-part of application Ser. No. 10/840,974 entitled “Containers and Container Assemblies With Releasable Locking Feature” filed on May 7, 2004, which is a continuation of application Ser. No. 10/277,303 entitled “Containers and Container Assemblies With Releasable Locking Feature” filed on Oct. 22, 2002 that issued as U.S. Pat. No. 6,886,704.

### FIELD OF INVENTION

The present invention relates generally to methods of using a container assembly. More particularly, the present invention relates to methods of using a releasably lockable container assembly.

### BACKGROUND OF THE INVENTION

The use of inexpensive polymeric, paper or metal packaging containers has become popular, especially for preparing and serving various food products. Polymeric, paper and metal containers generally have been used for heating the food product(s) disposed therein. These containers typically comprise a cover or lid and a base.

It would be desirable to have a method of using a container assembly that would be easy for the customer to close and open. This is especially important for users who may have difficulty in closing and opening a container assembly. It would also be desirable to provide a container assembly that is releasably lockable and prevents or inhibits material, such as liquid, from leaving the container assembly.

### SUMMARY OF THE INVENTION

According to one method of using a container assembly, a first container and a second container are provided. The first container includes a first continuous body portion and a first rim. The first rim encompasses and projects laterally outwardly from the first body portion. The rim has a first plurality of ribs projecting generally upwardly therefrom such that first spaces are formed between adjacent ribs. The second container includes a second continuous body portion and a second rim. The second rim encompasses and projects laterally outwardly from the second body portion. The rim has a second plurality of ribs projecting generally upwardly therefrom such that second spaces are formed between adjacent ribs. The first container is shaped substantially the same as the second container. It is contemplated that the first and second container may be shaped differently, but the first and second rims are shaped substantially the same.

The first plurality of upwardly-projecting ribs is fitted into respective second spaces and the second plurality of upwardly-projecting ribs is fitted into respective first spaces such that the first container and the second container are releasably lockable to each other. The container assembly is disassembled by exerting downward pressure on either the first or second continuous body portion that results in separation of the first and second rims. Such a process enables easy disassembly of the container.

### BRIEF DESCRIPTION OF THE DRAWINGS

FIG. 1 is a side view of a container to be used in one embodiment of the invention;

FIG. 2 is a top view of the container of FIG. 1;

FIG. 3 is an enlarged cross-sectional view taken generally along lines FIG. 3-FIG. 3 in FIG. 2;

FIG. 4 is an enlarged top view of generally circular region FIG. 4 of FIG. 2;

FIG. 5. is a perspective view of generally circular region FIG. 5 of FIG. 2 depicting two adjacent projecting ribs;

FIG. 6 is a sectional view of generally circular region FIG. 6 of FIG. 1 according to one embodiment.

FIG. 7a is a side view of a container assembly in a releasably lockable position using the container of FIG. 1 and a second identical container of FIG. 1 according to one embodiment of the present invention;

FIG. 7b is a top view of the container assembly of FIG. 7a;

FIG. 8 is an enlarged cross-sectional view taken generally along lines FIG. 8-FIG. 8 in FIG. 7b;

FIG. 9 is a side view of a container to be used in another embodiment of the invention;

FIG. 10 is a top view of the container of FIG. 9;

FIG. 11 is an enlarged top view of generally circular region FIG. 11 of FIG. 10;

FIG. 12 is a perspective view of generally circular region FIG. 11 of FIG. 10 depicting two adjacent projecting ribs;

FIG. 13 is an enlarged cross-sectional view taken generally along lines FIG. 13-FIG. 13 in FIG. 12;

FIG. 14a is a side view of a container assembly in a releasably lockable position using the container of FIG. 9 and a second identical container of FIG. 9 according to another embodiment of the present invention;

FIG. 14b is a top view of the container assembly of FIG. 14a;

FIG. 15 is an enlarged cross-sectional view taken generally along lines FIG. 15-FIG. 15 in FIG. 14b;

FIG. 16a is a top view of yet another container to be used in the present invention; and

FIG. 16b is an enlarged cross-sectional view taken generally along lines FIG. 16b-FIG. 16b in FIG. 16a.

While the invention is susceptible to various modifications and alternative forms, specific embodiments thereof have been shown by way of example in the drawing and will herein be described in detail. It should be understood, however, that it is not intended to limit the invention to the particular forms disclosed but, on the contrary, the intention is to cover all modifications, equivalents, and alternatives falling within the spirit and scope of the invention as defined by the appended claims.

### DESCRIPTION OF ILLUSTRATIVE EMBODIMENTS

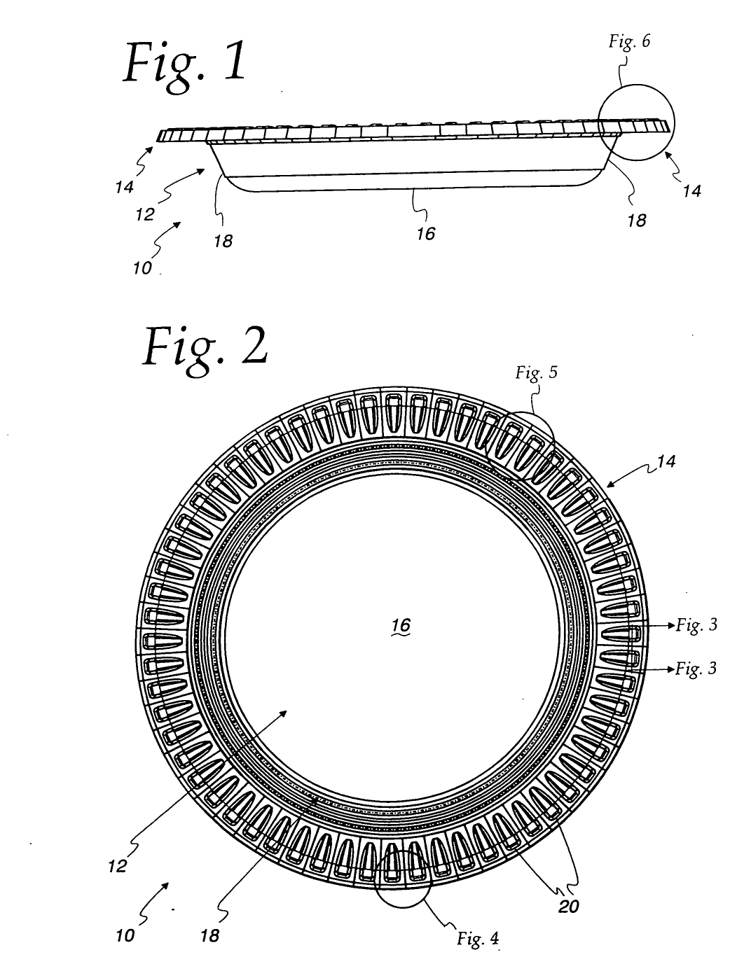

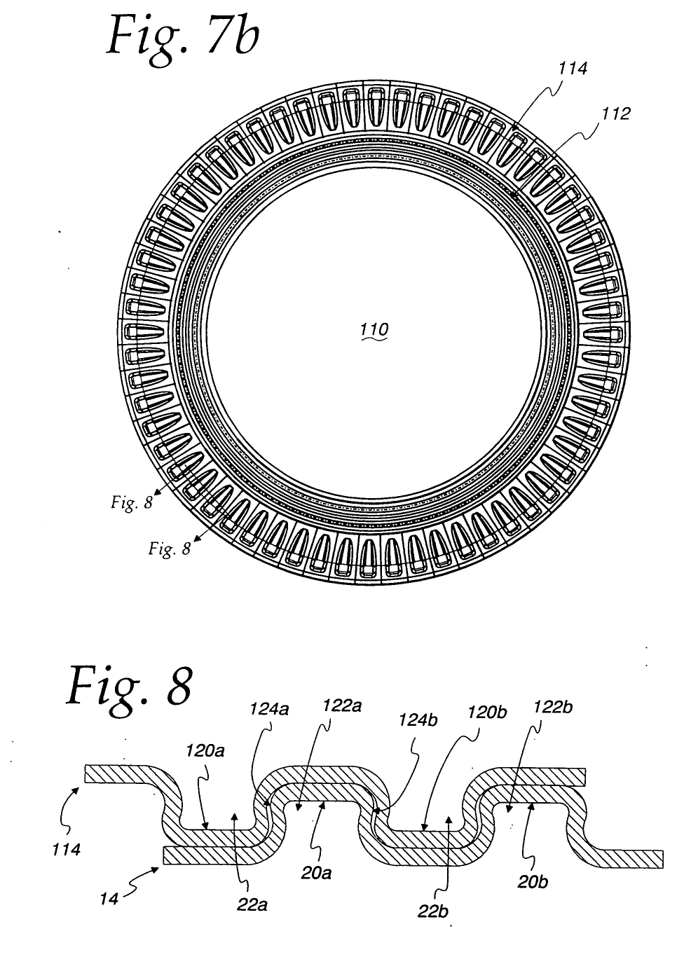

Referring to FIGS. 1-5, a container (e.g., plate 10) to be used in one embodiment of the present invention is shown. The plate 10 is used with a second plate 110 (see FIGS. 7 and 8) that may be substantially the same or, alternatively, identical to the plate 10 to form a container assembly that is releasably lockable.

It is contemplated that other container assemblies may be formed besides those using plates. For example, container assemblies may be formed, but are not limited to, using plates, bowls, platters, tubs, single-serve and family-size containers, single-serve and family-size ovenware, and combinations thereof. One such combination is a bowl and a plate that forms a container assembly. The remainder of the application will discuss container and container assemblies with respect to plates although it is recognized by one of ordinary skill in the art that other container assemblies, such as those discussed above, may be formed.

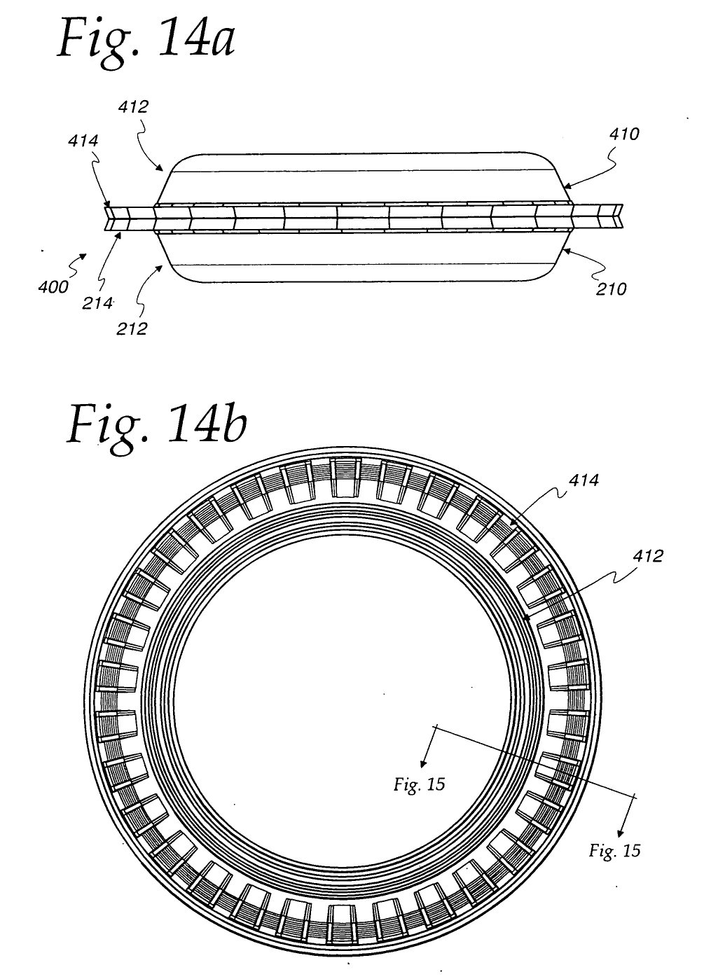

The height and shape of the container assembly may vary from that shown without departing from the scope of the invention. For example, the container assemblies of FIGS. 7a and 14a, as will be discussed, are depicted as being generally circular. It is contemplated that the container assemblies and containers used herein may be other shapes such as rectangular, square, hexagonal, octagonal, other polygonal shapes, or oval.

The container assemblies of the present invention are typically used with respect to food, but may be used in other applications such as with medical applications, cosmetics or other items. Food container assemblies may be used for serving, storing, preparing and/or re-heating the food.

Referring back to FIGS. 1-2, the container 10 includes a continuous body portion 12 and a continuous rim 14 encompassing and projecting laterally outwardly from the body portion 12. The body portion 12 includes a bottom 16 and a continuous sidewall 18 encompassing and projecting upwardly and outwardly from the bottom 16. It is contemplated that the sidewall may project only upwardly from the bottom 16 or even project upwardly and inwardly from the bottom 16. It is also contemplated that the rim may not be continuous, although it is preferred to be continuous.

Referring specifically to FIG. 2, the continuous rim 14 includes a plurality of ribs 20 that project generally upwardly therefrom. The plurality of ribs 20 is spaced around the general periphery of the container 10 and assists in forming a releasably lockable container assembly. The orientation of the plurality of ribs 20 creates a pattern that is generally normal to the direction of the rim 14. More specifically, the orientation of the plurality of ribs 20 may create a pattern that is normal to the direction of the rim 14. In a radial configuration with a pattern that is normal to the direction of the rim, each of the plurality of ribs 20, if extended inwardly, would pass through the general center of the plate.

The plurality of ribs 20, however, may be formed in different patterns than shown in FIG. 2 with respect to the rim 14 (e.g., diagonally). It may be desirable to form the plurality of ribs 20 in a decorative pattern for aesthetic reasons. Such a decorative feature may assist in “hiding” or disguising the releasable lockable feature in the container 10. The container 10 of FIG. 2 has exactly 60 ribs formed in the continuous rim 14. It is contemplated that the number of ribs may vary from that shown in FIG. 2. For example, a container may have from about 3 to about 10 ribs. A container may have greater than about 20 or about 40 ribs, and may even have up to or greater than about 120 ribs. The desired number of ribs formed on the container will often vary depending on factors such as the size or shape of the container assembly, the material(s) type and thicknesses of the container assembly, and the desired holding strength of the container assembly. The desired holding strength depends on factors such as the weight of item(s) placed in the container assembly and its perceived usage.

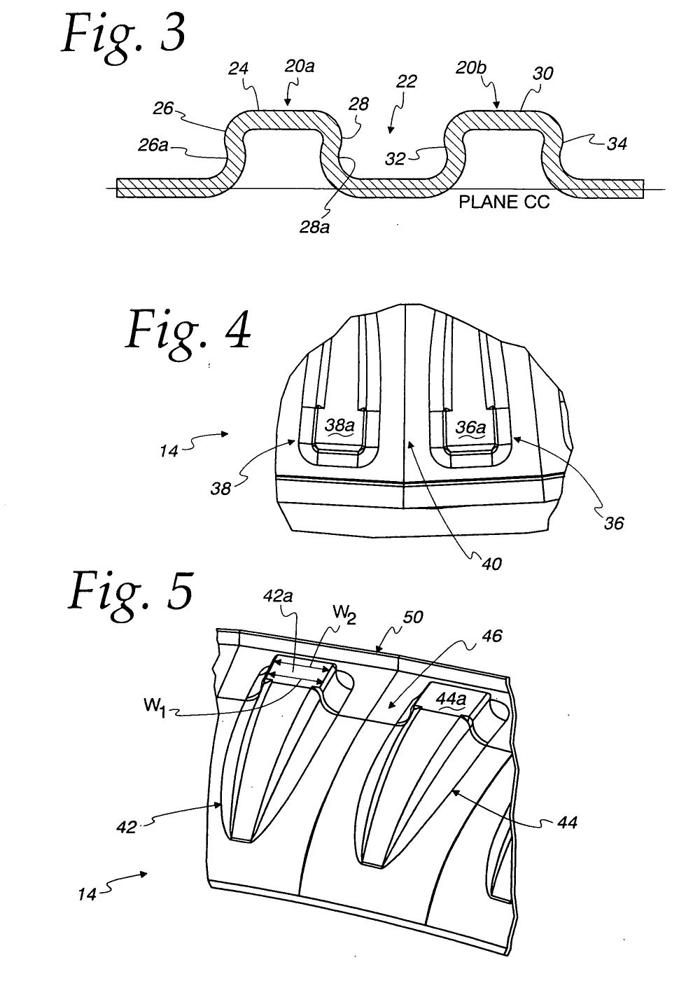

Turning to FIGS. 3-5, the plurality of ribs 20 is shown in greater detail. Specifically, a cross-sectional view of FIG. 3 shows two adjacent ribs that project upwardly from the continuous rim 14. FIG. 3 depicts a first rib 20a and a second rib 20b with a space 22 being formed therebetween. The first rib 20a of FIG. 3 comprises a generally flat surface 24 that bridges two sidewalls 26, 28. The first rib 20a is shown as being generally perpendicular to the plane of the remainder of the continuous rim 14. Specifically, the first rib 20a is shown as being generally perpendicular to plane CC formed along the remainder of the rim 14 in FIG. 3. More specifically, the rib may be perpendicular to the plane of the remainder of the rim. The sidewalls 26, 28 are spaced apart from each other and are shown as being generally perpendicular to the plane CC of the remainder of the rim 14. The sidewalls 26, 28, however, do not necessarily have to be generally perpendicular or perpendicular to the remainder of the rim 14.

Similarly, second rib 20b of FIG. 3 comprises a generally flat surface 30 that bridges two sidewalls 32, 34. The second rib 20b is also shown as being generally perpendicular to the plane CC of the remainder of the rim 14. The sidewalls 32, 34 are spaced apart from each other and are shown as being generally perpendicular to the plane CC of the remainder of the rim 14.

To provide an improved locked container assembly, at least one of the rib sidewalls may have an undercut. Such an optional undercut formed in the rib sidewall engages a similar undercut in a corresponding space formed between adjacent ribs of a second container when the container assembly is formed. This is discussed below in further detail with respect to FIGS. 7-8. For example, in FIG. 3, optional undercuts 26a, 28a are formed in respective sidewalls 26, 28. The size and shape of the undercut will often vary depending on factors such as the size or shape of the container assembly, the material(s) type and thicknesses of the container assembly, and the desired holding strength of the container assembly. The desired holding strength may depend on factors such as the weight of item(s) placed in the container assembly and its perceived usage.

The number of undercuts formed in the rib sidewalls, if any, depends on factors such as the desired leak-resistant, the type of closure mechanism, manufacturability of the container assemblies, and the material(s) type and thicknesses used in forming the container assemblies. For example, if the container assemblies are made of a first material that has a higher coefficient of friction than a second material, then the container made of the first material will likely need less undercuts in its sidewalls than the same container made with the second material to have the same holding strength. The number of undercuts used also depends on the fitness of use of the container assembly, including the holding strength thereof.

It is contemplated that the ribs may have sidewalls with no undercuts or at least one undercut (e.g., first rib 20a with optional undercuts 26a, 28a in FIG. 3). It is also contemplated that some ribs within the same container may have no undercuts, while other ribs may have one or more undercuts.

Referring to FIGS. 4 and 5, adjacent ribs 36, 38 of a portion of the rim 14 are shown in more detail. In FIG. 4, a top view of the ribs 36, 38 shows that the ribs 36, 38 generally taper inwardly toward the center of the container. FIG. 4 also shows a generally flat area 36a of rib 36 and a generally flat area 38a of rib 38. To improve the sealability of the container assembly, the generally flat areas 36a, 38a may contact similar sized flat areas formed in the respective spaces between adjacent ribs of a second container that form the container assembly. An example of a similar sized flat area formed in a space between adjacent ribs is shown in FIG. 4 with generally flat area 40.

FIG. 5 shows adjacent ribs 42, 44 with respective generally flat areas 42a, 44a. The ribs 42, 44 are spaced apart with a generally flat area 46 that is formed between generally flat areas 42a, 44a. To maintain clearances on radial designs (e.g., oval or circular shaped), the generally flat areas may grow proportionally with the diameter (i.e., increase in size as the distance increases from the center of the container). For example, in FIG. 5, the width W1 of generally flat area 42a may be smaller than width W2. With, for example, rectangular-shaped containers, the size of the generally flat areas typically remains constant as the distance increases from the center of the container. It is contemplated that this area of the ribs may be sized and shaped differently than shown in FIGS. 4 and 5.

It is contemplated that the shape and size of the plurality of ribs 20 may vary from that shown in FIGS. 2-5. It is preferred that the plurality of ribs be shaped and sized to minimize the stacking height of the containers used to form container assemblies. It is desirable to minimize the stacking height of the containers to (a) reduce transportation costs and packaging, and (b) provide space efficiency in retail and consumer settings. It is also desirable to maximize the holding strength of the container assembly. The desired holding strength is often a balance between making the container assembly easy for a consumer to open and close, while still preventing or inhibiting an inadvertent opening of the container assembly.

It is contemplated that the upwardly projecting features may be shaped differently than the ribs shown in FIGS. 2-5 and 11-13. For example, the upwardly projecting features may be a plurality of round, oval, square, or polygonal features. It is contemplated that many shapes and sizes may be formed by the upwardly projecting features used in the present invention.

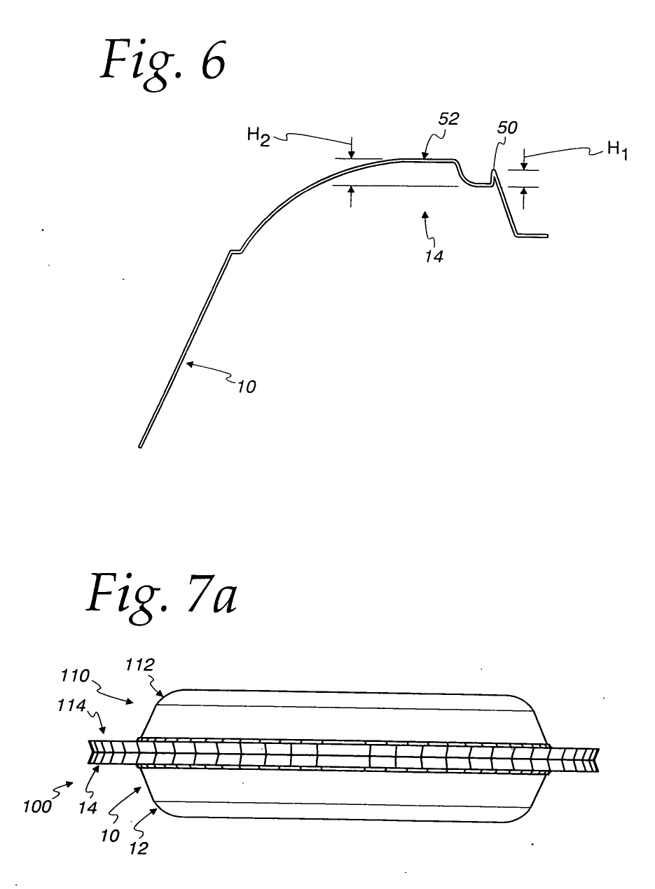

Referring to FIGS. 5 and 6, an optional seal feature 50 formed on the rim 14 is depicted. In FIG. 6, the optional seal feature 50 is located outwardly from the rib 52 with respect to the center of the container 10. In other words, the optional seal feature 50 is located farther away from the center of the container 10 than the rib 52. The optional seal feature 50 in conjunction with a corresponding optional seal feature on another container (not shown), along with the locked ribs of the container assembly, assist in preventing or inhibiting material from leaving or entering the container assembly. The optional seal feature is especially useful in preventing or inhibiting product leakage that may occur due to tolerances within the manufacturing process. To provide an efficient seal, the height H1 of the optional seal feature 50 should be at least one-half of the rib height H2.

The optional seal feature, however, may be located inwardly from the ribs such that the seal is formed nearer the center of the container assembly as compared to the releasably lockable ribs. For example, in FIGS. 16a and 16b, a container 510 includes a plurality of ribs 520 and also includes an optional seal feature 550. In FIGS. 6 and 16b, the optional seal feature 550 is located inwardly from the plurality of ribs 520 with respect to the center of the container 510. The optional seal feature 550 in conjunction with a corresponding seal feature on another container (not shown), along with the locked ribs of the container assembly, assist in preventing or inhibiting material from leaving or entering the container assembly. The optional seal feature may be formed in a variety of shapes, including a general conical shape.

A container assembly 100 according to one embodiment of the present invention is depicted in FIGS. 7a, 7b. The container 100 comprises the first container 10 and a second container 110. In one embodiment, the second container 110 is shaped substantially the same as the first container 10. Alternatively, the second container 110 may be identical to the first container 10. It may be desirable to have containers identically shaped to reduce waste by a consumer when the top container or lid is not used. As discussed above, the container assembly may be formed with different first and second containers than plates.

The container assembly 100 of FIGS. 7a, 7b may be formed according to one method by providing the first container 10 and the second container 110. The second container 110 includes a continuous body portion 112 and a continuous rim 114 that encompasses and projects laterally outwardly from the body portion 112. Similarly, the first container 10, as discussed above, includes the continuous body portion 12 and the continuous rim 14 that encompasses and projects laterally outwardly from the body portion 12. Both of the rims 14, 114 include a respective plurality of ribs with spaces therebetween (not shown in FIGS. 7a, 7b). Each of the plurality of ribs may be shaped and sized similarly to the ribs 20 shown above in FIGS. 2-5. Each of the plurality of ribs projects generally upwardly therefrom (i.e., in a direction away from the continuous body portion).

The second container 110 is flipped 180 degrees relative to the first container 10 such that the containers 10, 110 are generally aligned and the rims 14, 114 are adjacent to each other. This flipped position of container 110 relative to the container 10 is shown in FIG. 7a. To fit the ribs into respective spaces, the container 110 may have to be rotated slightly such that the ribs are offset (i.e., the ribs and spaces are aligned). It is desirable that the consumer can assembly the containers so as to form a container assembly of the present invention.

Referring to FIG. 8, adjacent ribs 120a, 120b of the container 110 are fit into respective second spaces 22a, 22b of the container 10 and ribs 20a, 20b of the container 10 are fit into respective spaces 122a, 122b such that the container assembly 100 is releasably lockable. To fit the ribs into respective spaces, the container 110 may have to be rotated slightly such that the ribs are offset (i.e., the ribs and spaces are aligned). FIG. 8 also depicts interference areas 124a, 124b formed between the first rib 20a and the space 122a created between ribs 120a, 120b of the container 110.

The strength of this lockable closure is dependent on many variables such as the number of the projecting ribs, the height of those ribs, whether undercuts are included, the size of the contact areas, the clearance needed between spaces and ribs, and the material(s) type and thickness used in forming the container assemblies. To improve the lockability of the container assembly, as discussed above, an optional sealing feature may be added.

The lockable closure feature of formed container assembly 100 of FIGS. 7a, 7b may be opened, disassembling container assembly 100 into separate first and second containers 10, 110 according to one method by providing pressure on continuous body portion 112. For example, exerting downward pressure on body portion 112 results in separation of the rims 14, 114, thereby enabling the easy disassembly of container assembly 100 into containers 10, 110. In a preferred embodiment, the downward pressure is applied in a substantially uniform manner across the surface area of body portion 112 that comprises the horizontal top of container assembly 100 as depicted in FIG. 7a. Such pressure may be applied, for example, by the palm of a user's hand. However, as part of the ergonomic design of this embodiment, pressure may be applied by any suitable means, including for example by the user's forearm or elbow or by using any device that is capable of applying pressure to body portion 112. In this manner, the ergonomic design of this embodiment enables release or opening of the lockable closure feature of the formed container assembly 100 in a manner that does not require use of one's hands and/or manual dexterity with one's hands or fingers.

The ease with which the lockable closure feature may be released or opened by using this pressure method depends upon several variables such as the degree of contour or arc of continuous body portion 112, the design and geometry of rims 14, 114, and the material(s) type and thickness used in forming the containers 10, 110.

According to one method of using a container assembly, a first container and a second container are provided. The first container includes a first continuous body portion and a first rim. The first rim encompasses and projects laterally outwardly from the first body portion. The rim has a first plurality of ribs projecting generally upwardly therefrom such that first spaces are formed between adjacent ribs. The second container includes a second continuous body portion and a second rim. The second rim encompasses and projects laterally outwardly from the second body portion. The rim has a second plurality of ribs projecting generally upwardly therefrom such that second spaces are formed between adjacent ribs. The first container is shaped substantially the same as the second container. It is contemplated that the first and second container may be shaped differently, but the first and second rims are shaped substantially the same.

The first plurality of upwardly-projecting ribs is fitted into respective second spaces and the second plurality of upwardly-projecting ribs is fitted into respective first spaces such that the first container and the second container are releasably lockable to each other. The container assembly is disassembled by exerting downward pressure on either the first or second continuous body portion that results in separation of the first and second rims. Such a process enables easy disassembly of the container.

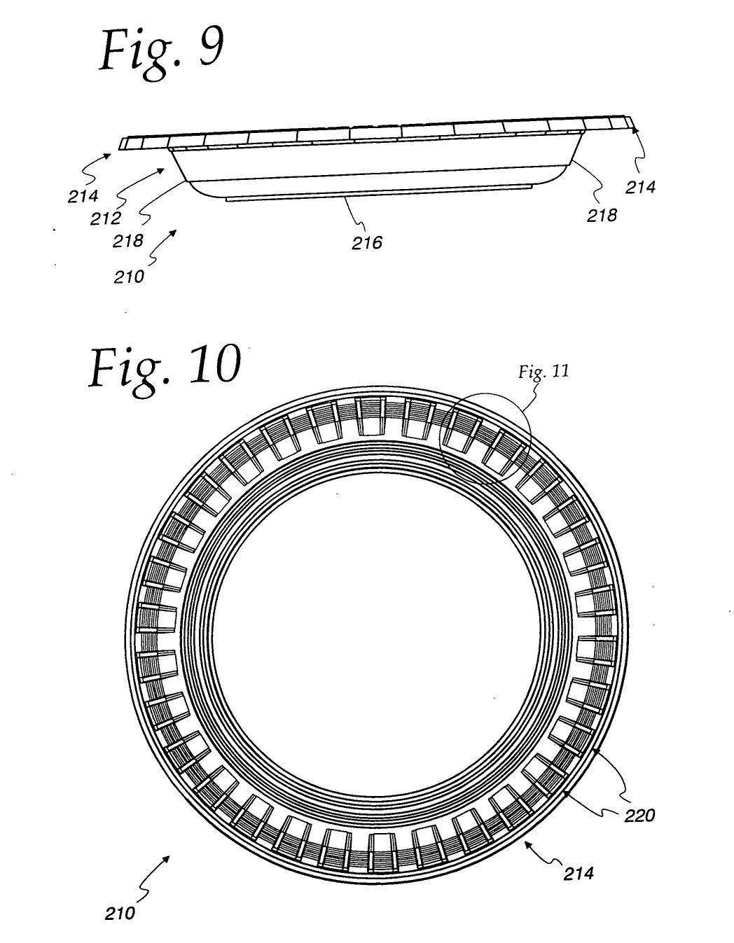

Referring to FIGS. 9-10, a container (e.g., plate 210) includes a continuous body portion 212 and a continuous rim 214 encompassing and projecting laterally outwardly from the body portion 212. The body portion 212 includes a bottom 216 and a continuous sidewall 218 encompassing and projecting upwardly and outwardly from the bottom 216. It is contemplated that the sidewall may project only upwardly from the bottom 216 or even project upwardly and inwardly from the bottom 216. It is also contemplated that the rim may not be continuous, although it is preferred to be continuous.

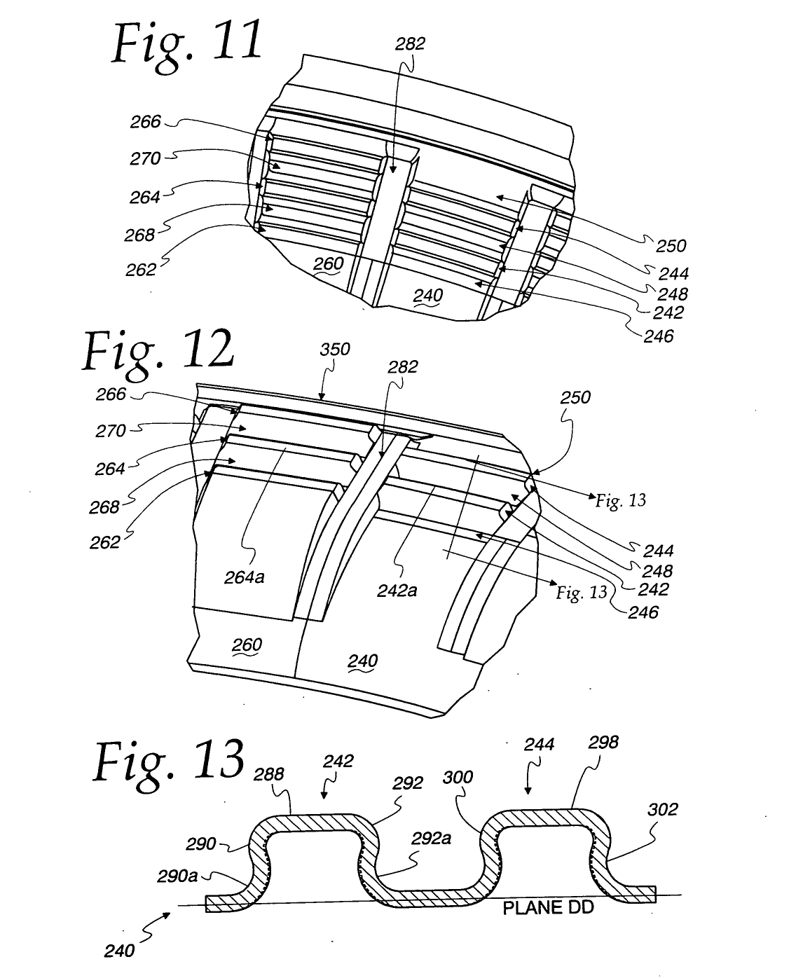

Referring to FIGS. 10 and 11, the continuous rim 214 includes a plurality of rib sets 220 that project generally upwardly therefrom. The plurality of rib sets 220 is spaced around the general periphery of the container 210 and assists in forming a releasably lockable container assembly. The orientation of the plurality of rib sets 220 creates a pattern that is generally parallel or generally concentric with the general direction of the rim 214. In other words, each of the plurality of rib sets 220, if extended outwardly, would be no closer to the general center of the container 210. The plurality of rib sets 220 is in the opposite direction of the plurality of ribs 20 in FIGS. 2-5.

The plurality of rib sets 220, however, may be formed in different patterns than shown in FIG. 10 with respect to the rim 214 (e.g., diagonally). It may be desirable to form the plurality of rib sets 220 in a decorative pattern for aesthetic reasons. Such a decorative feature may assist in “hiding” or disguising the releasable lockable feature in the container 210.

The container 210 of FIG. 10 has exactly 60 sets of ribs formed in the continuous rim 214. As will be discussed in more detail below, each of the plurality of rib sets 220 has a first set of ribs on a raised portion and a second set of ribs on a recessed portion. It is contemplated that the number of rib sets may vary from that shown in FIG. 10. For example, a container may have from about 2 to about 30 sets of ribs. A container may have greater than about 40 or about 80 sets of ribs, and may even have up to or greater than about 120 sets of ribs. The desired number of ribs formed on the container will often vary depending on factors such as the size or shape of the container assembly, the material(s) type and thicknesses of the container assembly, and the desired holding strength of the container assembly. The desired holding strength may depend on factors such as the weight of item(s) placed in the container assembly and its perceived usage.

Turning to FIGS. 11-13, two adjacent sets of ribs are shown in greater detail. The number of ribs in a set varies in FIGS. 11 and 12 depending on whether the ribs are located in a recessed area or a raised area formed in the rim 214. For example, in FIGS. 11 and 12, recessed area 240 has a first rib 242 and a second rib 244 with spaces 246, 248 and 250. Raised area 260 of FIGS. 11 and 12, however, has a first rib 262, a second rib 264, and a third rib 266 with spaces 268, 270 therebetween. Each of the ribs of FIGS. 11 and 12 projects upwardly from the continuous rim 214.

Referring specifically to FIG. 13, a cross-sectional view of the recessed area 240 is depicted and includes the ribs 242, 244. A cross-sectional view of the raised area 260 (not shown) would depict three ribs. The first rib 242 of FIG. 13 comprises a generally flat surface 288 that bridges two sidewalls 290, 292. The first rib 242 is shown as being generally perpendicular to the plane of the remainder of the continuous rim 214. Specifically, the first rib 242 is shown as being generally perpendicular to plane DD formed along the remainder of the rim 214 in FIG. 13. More specifically, the rib may be perpendicular to the plane of the remainder of the rim. The sidewalls 290, 292 are spaced apart from each other and are shown as being generally perpendicular to the plane DD of the remainder of the rim 214. The sidewalls 290, 292, however, do not necessarily have to be generally perpendicular or perpendicular to the remainder of the rim 214.

Similarly, second rib 244 of FIG. 13 comprises a generally flat surface 298 that bridges two sidewalls 300, 302. The second rib 244 is also shown as being generally perpendicular to the plane DD of the remainder of the rim 214. The sidewalls 300, 302 are spaced apart from each other and are shown as being generally perpendicular to the plane DD of the remainder of the rim 214.

To provide an improved locked container assembly, at least one of the rib sidewalls may have an optional undercut. As discussed above, such an undercut formed in the rib sidewall engages a similar undercut in the spaces formed between adjacent ribs when the container assembly is formed. For example, in FIG. 13, optional undercuts 290a, 292a are formed in respective sidewalls 290, 292. The size and shape of the undercut will often vary depending on factors such as the size or shape of the container assembly, the material(s) type and thicknesses of the container assembly, and the desired holding strength of the container assembly. The desired holding strength may depend on factors such as the weight of item(s) placed in the container assembly and its perceived usage.

As discussed above, the number of undercuts formed in the rib sidewalls, if any, depends on several factors. It is contemplated that the ribs may have sidewalls with no undercuts or at least one undercut (e.g., first rib 242 with optional undercuts 290a, 292a in FIG. 13). It is also contemplated that some ribs within the same container may have no undercuts, while other ribs have one or more undercuts.

Referring back to FIG. 12, the raised and recessed areas 240, 260 have a plurality of ribs with generally flat areas. For example, the rib 242 includes a top surface or generally flat area 242a. Similarly, the rib 264 includes a top surface or generally flat area 264a. To improve the sealability of the container assembly, the generally flat areas 264a, 242a may contact similar sized flat areas formed in the spaces formed between adjacent ribs of a second container that forms the container assembly. An example of a similar sized flat area formed in a space is depicted in FIG. 12 with space 246. As shown in FIG. 12, a generally flat area 282 is formed between adjacent sets of ribs (i.e., the raised and recessed portions) to assist in releasably locking the container assembly. It is contemplated that this area of the ribs may be sized and shaped differently than shown in FIGS. 11-13. It is contemplated that the numbers of ribs in a set of ribs may vary from that shown in FIGS. 11 and 12 (two ribs in the recessed areas and three ribs in the raised areas)

It is contemplated that the shape and size of the plurality of ribs 220 may vary from that shown in FIGS. 10-13. It is preferred that the plurality of ribs be shaped and sized to minimize the stacking height of the containers. It is desirable to minimize the stacking height of the containers to (a) reduce transportation costs and packaging, and (b) provide space efficiency in retail and consumer settings. It is also desirable to maximize the holding strength of the container assembly. The desired holding strength is often a balance between making the container assembly easy for a consumer to open and close, while still preventing or inhibiting an inadvertent opening of the container assembly.

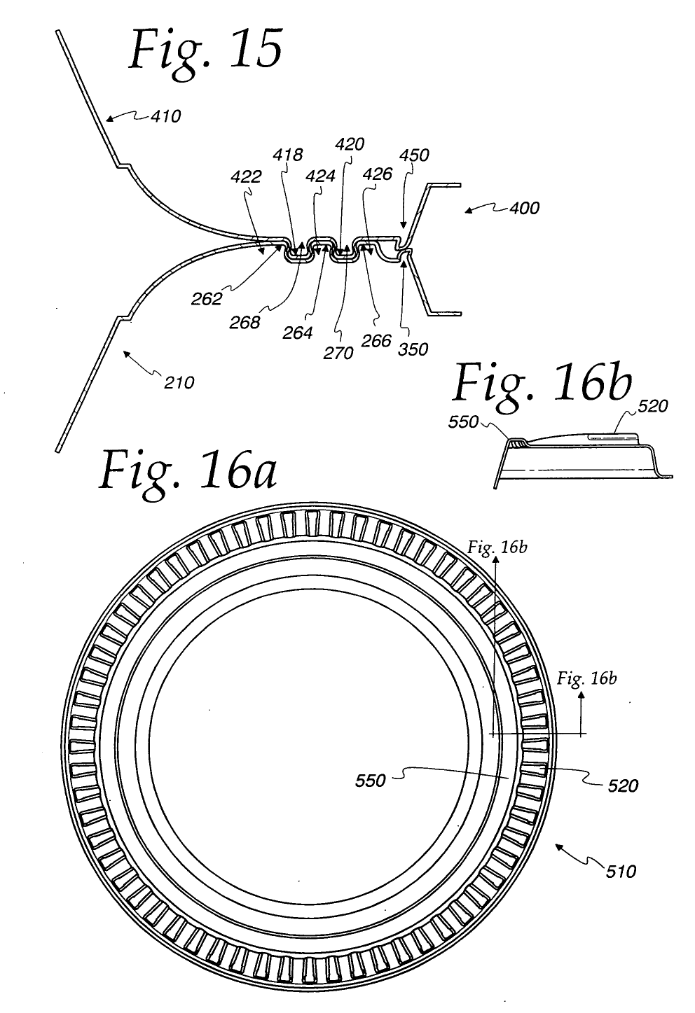

Referring specifically to FIG. 12, an optional seal feature 350 formed on the rim 214 is depicted. The optional seal feature 350 is located outwardly from the ribs 242, 244, 262, 264 and 266 with respect to the center of the container 210. In other words, the optional seal feature 350 is located farther away from the center of the container 210 than the ribs. The optional seal feature 350 in conjunction with a corresponding seal feature on another container (e.g., optional seal feature 450 shown in FIG. 15), along with the locked ribs of the container assembly, assist in preventing or inhibiting material from leaving or entering the container assembly. The optional seal feature is especially useful in preventing or inhibiting product leakage that may occur due to tolerances within the manufacturing process. To provide an efficient seal, the height of the optional seal feature should be at least one-half of the rib height. This is shown in FIG. 15 where the optional seal features 350 and 450 contact each other.

As discussed above with respect to FIGS. 16a, b above, the optional seal feature, however, may be located inwardly from the ribs such that the seal is formed nearer the center of the container assembly as compared to the releasably lockable ribs.

A container assembly 400 according to one embodiment of the present invention is depicted in FIGS. 14a, 14b. The container 400 comprises the first container 210 and a second container 410. In one embodiment, the second container 410 is shaped substantially the same as the first container 210. Alternatively, the second container 410 may be identical to the first container 210. As discussed above, the container assembly may be formed with different first and second containers than plates. For example, the container assembly may be formed using a bowl and a plate.

The container assembly 400 of FIGS. 14a, 14b may be formed according to one method by providing the first container 210 and the second container 410. The second container 410 includes a continuous body portion 412 and a continuous rim 414 that encompasses and projects laterally outwardly from the body portion 412. Similarly, the first container 210, as discussed above, includes the continuous body portion 212 and the continuous rim 214 that encompasses and projects laterally outwardly from the body portion 212. Both of the rims 214, 414 include a respective plurality of ribs with spaces therebetween (not shown in FIGS. 14a, 14b). Each of the plurality of ribs may be shaped and sized similarly to the ribs 220 shown above in FIGS. 10-13. Each of the plurality of ribs projects generally upwardly therefrom (i.e., in a direction away from the continuous body portion).

As discussed above with container assembly 100, the second container 410 is flipped 180 degrees relative to the first container 210 such that the containers 210, 410 are generally aligned and the rims 214, 414 are adjacent to each other. This flipped position of the container 410 relative to the container 210 is shown in FIG. 14a.

Referring to FIG. 15, adjacent ribs 262, 264, 266 of one set of the container 210 are fit into respective second spaces 422, 424, and 426 of the container 410 and ribs 418, 420 of the container 410 are fit into respective spaces 268, 270 such that the container assembly 400 is releasably lockable.

The strength of this lockable closure is dependent on many variables such as the number of the projecting ribs, the height of those ribs, whether undercuts are included, the size of the contact areas, the clearance needed between spaces and ribs, and the material(s) type and thickness used in forming the container assemblies. To improve the lockability of the container assembly, as discussed above, an optional sealing feature may be added.

The container assemblies of the present invention are typically formed from polymeric materials, but may be formed from materials such as paper or metal. The polymeric containers may be formed from polyolefins. The polymeric food containers are typically formed from orientated polystyrene (OPS), polyethylene terephthalate (PET), polyvinyl chloride (PVC), polypropylene and combinations thereof. The containers assemblies may be made from a mineral-filled polymeric material such as, for example, talc or calcium carbonate-filled polyolefin. An example of paper that may be used in forming the container assemblies is paperboard or molded fiber. Paperboard and molded fiber typically have a sufficient coefficient of friction to maintain the first and second containers in a lockable position.

As discussed, the materials used in forming the container assembly may assist in releasably locking the container assembly. For example, the material(s) forming the container assembly may have a fairly tacky laminate on one side that corresponds with a fairly tacky laminate on the opposing side, resulting in a desirable releasably lockable container assembly.

It is contemplated that the containers used in forming the container assemblies may be made from different materials. It is contemplated that one of ordinary skill in the art will recognize that other polymers or combination of polymers may be used to form the containers.

The container assemblies of the present invention are typically disposable, but it is contemplated that they may be reused at a future time. The containers used in forming the container assemblies (e.g., container 10) are shown as including one compartment. It is contemplated that the containers may be formed of multiple compartments. Such containers are desirable for placing items (e.g., food items) in different compartments to prevent or inhibit commingling of items. For example, undesirable mixing of food items can corrupt the flavor and the consistency of the food items.

As discussed above, the container assemblies may be used with food items. A method of using such container assemblies includes placing the food and locking the containers to form a container assembly with food therein. The container assembly is then placed in a heating apparatus and heated. Typical heating apparatuses include microwaves and conventional ovens. The container assemblies may contain solid food products. The container assemblies may be used for storage in the refrigerator and/or the freezer.

The containers to be used in forming the container assemblies of the present invention may be formed using conventional thermoforming (e.g., by pressure, vacuum or the combination thereof), injection-molding processes, or rotational molding. According to one method of thermoforming, pellets of a polymeric resin and additives, if any, are added into an extruder. The pellets of the polymeric resin and additives, if any, are melted to form a blend. The blend is extruded through a die to form an extruded sheet. The extruded sheet is thermoformed to a desired shape of a container to be used in forming the container assembly.

The thickness of the container to be used in forming the container assemblies generally ranges from about 0.002 to about 0.15 inch, but is typically from about 0.005 to about 0.04 inch. The container assemblies may be opaque or a variety of colors or color combinations. The container assemblies typically have at least one transparent container if it is desired for the customer to ascertain the nature of the accommodated product and the condition thereof without having to open the container assembly.

While particular embodiments and applications of the present invention have been illustrated and described, it is to be understood that the invention is not limited to the precise construction and compositions disclosed herein and that various modifications, changes, and variations may be apparent from the foregoing descriptions without departing from the spirit and scope of the invention as defined in the appended claims.

What is claimed is:

1. A method of opening a container assembly, the method comprising the acts of:
providing a container assembly comprising a first container and a second container, the first container including a first continuous body portion and a first rim, the first rim encompassing and projecting laterally outwardly from the first body portion, the rim having a first plurality of features projecting generally upwardly therefrom such that first spaces are formed between adjacent features, the second container including a second continuous body portion and a second rim, the second rim encompassing and projecting laterally outwardly from the second body portion, the rim having a second plurality of features projecting generally upwardly therefrom such that second spaces are formed between adjacent features, the second rim and the first rim being shaped substantially the same, the first container and the second container being releasably engageable to each other to form the container assembly by fitting the first plurality of upwardly-projecting features into respective second spaces and fitting the second plurality of upwardly-projecting features into respective first spaces; and
opening the container assembly by exerting downward pressure on either the second continuous body portion or the first continuous body portion resulting in the disengagement of the first and second rims from each other.

2. The method of claim 1 wherein the first plurality of upwardly-projecting features is ribs and the second plurality of upwardly-projecting features is ribs.

3. The method of claim 1 wherein the first and second containers are made of polymeric material.

4. The method of claim 1 wherein the first rim is identical to the second rim.

5. The method of claim 1 wherein the first plurality of upwardly-projecting features creates a first pattern that is generally normal to the direction of the first rim, and the second plurality of upwardly-projecting features creates a second pattern that is generally normal to the direction of the second rim.

6. The method of claim 1 wherein each of the first plurality of upwardly-projecting features is generally concentric with the center of the first container and each of the second plurality of upwardly-projecting features is generally concentric with the center of the second container.

7. The method of claim 1 wherein each of the first plurality of upwardly-projecting features and the second plurality of upwardly-projecting features includes at least about 3 ribs.

8. The method of claim 1 wherein each of the first plurality of upwardly-projecting features and the second plurality of upwardly-projecting features includes at least about 20 ribs.

9. The method of claim 1 wherein the first rim and the second rim are adapted to form a seal.

10. The method of claim 1 further including placing a food article on at least one of the first container and the second container before fitting the first plurality of upwardly-projecting features into respective second spaces and fitting the second plurality of upwardly-projecting features into respective first spaces.

11. The method of claim 1 wherein the first plurality of upwardly-projecting features has at least on undercut and the second plurality of upwardly-projecting features has at least one undercut.

12. The method of claim 1 wherein the first plurality of upwardly-projecting features is square shaped and the second plurality of upwardly-projecting features is square shaped.

13. The method of claim 1 wherein the first plurality of upwardly-projecting features is rectangular shaped and the second plurality of upwardly-projecting features is rectangular shaped.

14. The method of claim 1 wherein the downward pressure is applied in a substantially uniform manner.

15. A method of opening a container assembly, the method comprising the acts of:
providing a container assembly comprising a first container and a second container, the first container including a first continuous body portion and a first rim, the first rim encompassing and projecting laterally outwardly from the first body portion, the rim having a first plurality of features projecting generally upwardly therefrom such that first spaces are formed between adjacent features, the second container including a second continuous body portion and a second rim, the second rim encompassing and projecting laterally outwardly from the second body portion, the rim having a second plurality of features projecting generally upwardly therefrom such that second spaces are formed between adjacent features, the first container and the second container being shaped substantially the same, the first container and the second container being releasably engageable to each other to form the container assembly by fitting the first plurality of upwardly-projecting features into respective second spaces and fitting the second plurality of upwardly-projecting features into respective first spaces; and
opening the container assembly by exerting downward pressure on either the second continuous body portion or the first continuous body portion resulting in the disengagement of the first and second rims from each other.

16. The method of claim 15 wherein the first plurality of upwardly-projecting features is ribs and the second plurality of upwardly-projecting features is ribs.

17. The method of claim 15 wherein the first and second containers are made of polymeric material.

18. The method of claim 15 wherein the first rim is identical to the second rim.

19. The method of claim 15 wherein the first plurality of upwardly-projecting features creates a first pattern that is generally normal to the direction of the first rim, and the second plurality of upwardly-projecting features creates a second pattern that is generally normal to the direction of the second rim.

20. The method of claim 15 wherein each of the first plurality of upwardly-projecting features is generally concentric with the center of the first container and each of the second plurality of upwardly-projecting features is generally concentric with the center of the second container.

21. The method of claim 15 wherein each of the first plurality of upwardly-projecting features and the second plurality of upwardly-projecting features includes at least about 3 ribs.

22. The method of claim 15 wherein each of the first plurality of upwardly-projecting features and the second plurality of upwardly-projecting features includes at least about 20 ribs.

23. The method of claim 15 wherein the first rim and the second rim are adapted to form a seal.

24. The method of claim 15 further including placing a food article on at least one of the first container and the second container before fitting the first plurality of upwardly-projecting features into respective second spaces and fitting the second plurality of upwardly-projecting features into respective first spaces.

25. The method of claim 15 wherein the first plurality of upwardly-projecting features has at least on undercut and the second plurality of upwardly-projecting features has at least one undercut.

26. The method of claim 15 wherein the first plurality of upwardly-projecting features is square shaped and the second plurality of upwardly-projecting features is square shaped.

27. The method of claim 15 wherein the first plurality of upwardly-projecting features is rectangular shaped and the second plurality of upwardly-projecting features is rectangular shaped.

28. The method of claim 15 wherein the downward pressure is applied in a substantially uniform manner.
